(19) United States
(12) Patent Application Publication
(10) Pub. No.: US 2003/0006136 A1
(43) Pub. Date: Jan. 9, 2003

(54) Water electrolyzing system

(76) Inventors: Yutaka Hiki, Wako-shi (JP); Katsutoshi Nosaki, Wako-shi (JP); Hisashi Nagaoka, Wako-shi (JP); Satoshi Taguchi, Wako-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/122,417

(22) Filed: Apr. 16, 2002

(30) Foreign Application Priority Data
Jul. 3, 2001 (JP) 2001-202372

(51) Int. Cl. C25B 9/00; C25C 7/00; C25D 17/00; C25F 7/00; B23H 11/00

(52) U.S. Cl. 204/274; 204/275.1; 204/276; 204/278

(57) ABSTRACT

In a water electrolyzing system of a solar-power-generating type, a low power generated by a photovoltaic generator and not reaching a level required for the operation of a water electrolyzer is utilized effectively. A water electrolyzing system includes a water electrolyzer, a first photovoltaic generator which is a power source of the water electrolyzer, and at least one electric device, for example, an accumulating device and a heater for raising the temperature of water to be electrolyzed. When a power generated by the first photovoltaic generator is lower than a level required for the operation of the water electrolyzer, if the temperature of the water to be electrolyzed is lower than 80°, the generated power is supplied to the temperature-raising heater, or if T≧80°, the generated power is supplied to the accumulating device and accumulated therein.

### BACKGROUND OF THE INVENTION

The present invention relates to a water electrolyzing system, and particularly to a water electrolyzing system of a solar-power-generating type using a photovoltaic generator as a power source for a water electrolyzer.

During the period from the start of power generation by a photovoltaic generator to the point where the generated power reaches a level required for the operation of a water electrolyzer, the power being generated is not utilized. Power generated is also not utilized where the generated power drops below the level required for the operation of the water electrolyzer during water electrolysis. To enhance the water electrolyzing efficiency from the start of the water electrolysis, water to be electrolyzed is required to have a temperature of about 80° C. Therefore, water to be electrolyzed has been conventionally heated by a heater to which power is supplied from an external power source outside the system.

Although power generated by a photovoltaic generator is low, energy is wasted by not utilizing the generated power. Also, it is uneconomical to supply power to a heater through an external power source outside the system.

### SUMMARY OF THE INVENTION

It is an object of the present invention to provide a water electrolyzing system which efficiently utilizes a low power generated by a photovoltaic generator and thereby avoid wasting energy.

To achieve the above object, according to the present invention, there is provided a water electrolyzing system comprising a water electrolyzer, a photovoltaic generator which is a power source for the water electrolyzer, and at least one electric device. In the water electrolyzing system of the present invention, when power generated by the photovoltaic generator satisfies a level required for the operation of the water electrolyzer, the generated power is supplied to the water electrolyzer. Conversely, when the power generated is lower than the level required for the operation of the water electrolyzer, the generated power is supplied to the electric device. With this arrangement, the low power generated by the photovoltaic generator can be efficiently utilized to avoid wasting energy.

It is another object of the present invention to provide a water electrolyzing system, in which power supplied to a heater for raising the temperature of water to be electrolyzed can be procured from within the system.

To achieve the above object, there is provided a water electrolyzing system, in which the electric device is a heater for raising the temperature of water to be electrolyzed in the water electrolyzer. Thus, when the temperature T of the water to be electrolyzed is lower than 80° C., the generated power is supplied to the heater.

With this arrangement, the power supplied to the heater for raising the temperature of the water to be electrolyzed can be procured from within the system, thereby improving economical efficiency and water electrolyzing efficiency from the start of the water electrolysis.

### BRIEF DESCRIPTION OF THE DRAWING

FIG. 1 is a block diagram of the water electrolyzing system of the present invention.

### DETAILED DESCRIPTION OF THE PREFERRED EMBODIMENT

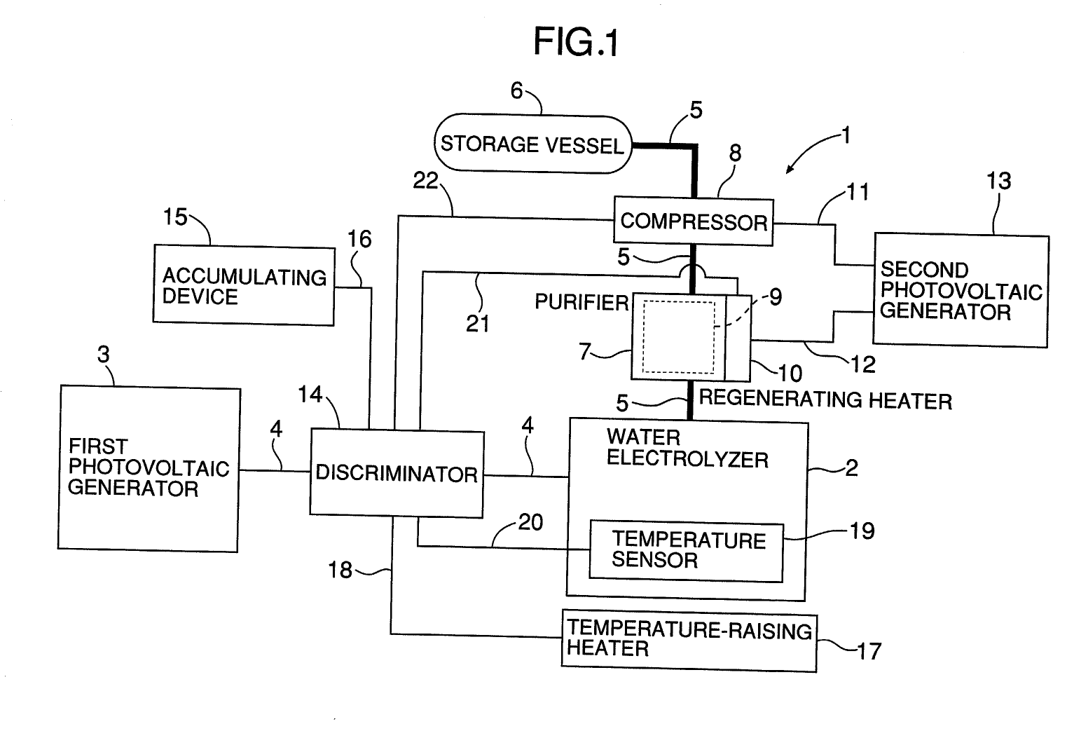

In a water electrolyzing system 1 shown in FIG. 1, a water electrolyzer 2 is connected through a feeder line 4 to a first photovoltaic generator 3, which is a power source of the water electrolyzer 2. An inlet of a supply pipe 5 is connected to a hydrogen supply portion of the water electrolyzer 2, and an outlet of the supply pipe 5 is connected to a storage vessel 6. A purifier 7 and a compressor 8 serving as a pressurizing device are mounted on the supply pipe 5 sequentially from the side of the water electrolyzer 2. The purifier 7 includes a molecular sieve 9 serving as an adsorbing material, and a regenerating heater 10 serving as a regenerating means for regenerating the molecular sieve 9 by heating. The purifier conducts a purifying treatment mainly for dehydration of hydrogen produced by the water electrolyzer 2. The compressor 8 and the regenerating heater 10 are connected to a second photovoltaic generator 13 through feeder lines 11 and 12, respectively. The power generated by the first photovoltaic generator 3 is larger than that generated by the second photovoltaic generator 13. A discriminator 14 is mounted on the feeder line 4 and determines whether the power generated by the first photovoltaic generator 3 is high or low, and supplies the generated power to the water electrolyzer 2 or a electric device.

There is at least one electric device in the water electrolyzing system 1. The present embodiment includes four electric devices. One of the electric devices is an accumulating device 15, for example, a storage battery, to which the discriminator 14 is connected through a first electric branch line 16. A capacitor may be used in place of the storage battery. Another one of the electric devices is a heater 17 for raising the temperature of water to be electrolyzed in the water electrolyzer 2. The discriminator 14 is connected to the heater 17 through a second electric branch line 18. A temperature sensor 19 for measuring the temperature of the water to be electrolyzed is connected to the discriminator 14 through a conducting wire 20. Other electric devices include the regenerating heater 10 of the purifier 7 and the compressor 8. The discriminator 14 is connected to the regenerating heater 10 and the compressor 8 through a third electric branch line 21 and a fourth electric branch line 22, respectively.

In the above-described arrangement, when the first photovoltaic generator 3 starts to generate power, the discriminator 14 determines whether the generated power is high or low. If the power generated by the first photovoltaic generator 3 is lower than a level required to operate the water electrolyzer 2, it is determined whether a temperature T of the water to be electrolyzed in the water electrolyzer 2 is lower than 80° C. or not. If T<80° C., the generated power is supplied to the temperature-raising heater 17. Thus, the power supplied to the temperature-raising heater 17 is procured from within the system, and the temperature T of the water to be electrolyzed is raised to around 80° C., thereby improving the water electrolyzing efficiency at the start of the water electrolysis. On the other hand, if T≧80° C., the generated power is supplied to the accumulating device 15 and accumulated therein. The accumulated power is utilized for water electrolysis and other purposes.

If the generated power reaches a level required for the operation of the water electrolyzer 2, the generated power is supplied to the water electrolyzer 2, where the electrolysis is carried out to produce hydrogen. On the other hand, the power generated by the second photovoltaic generator 13 activates the compressor 8, and the regenerating heater 10 is energized to raise the temperature thereof. The produced hydrogen is subjected to a purifying treatment mainly for dehydration through the molecular sieve 9 in the purifier 7. The purified hydrogen is pressurized by the compressor 8 and charged into the storage vessel 6. To regenerate the molecular sieve 9 of the purifier 7, the molecular sieve 9 is heated by the regenerating heater 10 from room temperature to a regenerating temperature, for example, 300° C., and maintained at such temperature for a predetermined time. Thus, moisture adsorbed in the molecular sieve 9 is evaporated, whereby the regeneration of the molecular sieve 9 is achieved. When the power generated by the first photovoltaic generator 3 temporarily drops, during water electrolysis, below the level required for the operation of the water electrolyzer 2, the generated power is supplied, for example, to the accumulating device 15 and accumulated therein.

When the power generated by the first photovoltaic generator 3 does not satisfy the level required for the operation of the water electrolyzer 2 near the time of sunset, when the source of solar power is reduced, the power generated by the second photovoltaic generator 13 also drops, so that sufficient power cannot be supplied to the regenerating heater 10 and the compressor 8. In such a case, the power generated by the first photovoltaic generator 3 is supplied to the compressor 8, to thereby pressurize the already produced hydrogen and charge it into the storage vessel 6; and the generated power is also supplied to the regenerating heater 10 to raise the temperature thereof, to thereby heat and regenerate the molecular sieve 9. The above-described operation of the compressor 8 and regeneration of the molecular sieve 9 are also carried out to capture the remaining hydrogen and to regenerate the unregenerated molecular sieve after starting the power generation by the first photovoltaic generator 3 and before starting the water electrolysis the next day.

According to the present invention, with the above-mentioned arrangement, it is possible to provide a water electrolyzing system which can efficiently utilize the low power generated by the photovoltaic generator when the power generated does not reach the level required for the operation of the water electrolyzer. As a result, the system of the present invention avoids wasting energy.

According to the present invention, it is possible to provide a water electrolyzing system which has an improved economical efficiency and water electrolyzing efficiency from the start of the water electrolysis.

According to the present invention, it is possible to provide a water electrolyzing system which can expand the use of the power generated by the photovoltaic generator.

1. A water electrolyzing system comprising a water electrolyzer, a photovoltaic generator which is a power source of the water electrolyzer, and at least one electric device,
wherein when a power generated by the photovoltaic generator satisfies a level required for the operation of the water electrolyzer, the generated power is supplied to the water electrolyzer, and when the power generated is lower than the level required for the operation of the water electrolyzer, the generated power is supplied to the at least one electric device.

2. The water electrolyzing system according to claim 1, wherein the at least one electric device is a heater for raising the temperature of water to be electrolyzed in the water electrolyzer, and wherein when the temperature of the water to be electrolyzed is lower than 80° C., the generated power is supplied to the heater.

3. The water electrolyzing system according to claim 1 or 2, wherein the at least one electric device is an accumulating device, and wherein when the temperature of the water to be electrolyzed is equal to or higher than 80° C., the generated power is supplied to the accumulating device.

4. The water electrolyzing system according to claim 1 or 2, further comprising a purifier for purifying hydrogen produced by the water electrolyzer, the at least one electric device being a regenerating means for the purifier.

5. The water electrolyzing system according to claim 1 or 2, wherein the at least one electric device is a pressurizing device for pressurizing the purified hydrogen and charging the purified hydrogen into a storage vessel.

6. The water electrolyzing system according to claim 3, further comprising a purifier for purifying hydrogen produced by the water electrolyzer, the at least one electric device being a regenerating means for the purifier.

7. The water electrolyzing system according to claim 3, wherein the at least one electric device is a pressurizing device for pressurizing the purified hydrogen and charging the purified hydrogen into a storage vessel.

8. The water electrolyzing system according to claim 4, wherein the at least one electric device is a pressurizing device for pressurizing the purified hydrogen and charging the purified hydrogen into a storage vessel.

9. The water electrolyzing system according to claim 5 further comprising a second photovoltaic generator connected to the pressurizing device to activate the pressurizing device when the photovoltaic generator reaches the level required for operation of the water electrolyzer.

10. The water electrolyzing system according to claim 4, wherein the purifier further includes an adsorbing material.

11. The water electrolyzing system according to claim 1, wherein the at least one electric device is a heater, an accumulating device, a regenerating means and/or a pressurizing device.
